(19) United States
(12) Patent Application Publication
(10) Pub. No.: US 2014/0296056 A1
(43) Pub. Date: Oct. 2, 2014

(54) FIBROUS PHOTO-CATALYST AND METHOD FOR PRODUCING THE SAME

(71) Applicant: Yu-Hsun Nien, Douliou City (TW)

(72) Inventors: Yu-Hsun Nien, Douliou City (TW); Hong-Chang Chen, Taichung City (TW)

(21) Appl. No.: 14/226,493

(22) Filed: Mar. 26, 2014

(30) Foreign Application Priority Data
Mar. 29, 2013 (TW) 102111340
Jan. 17, 2014 (TW) 103101793

(51) Int. Cl. B01J 23/50

(52) U.S. Cl. CPC B01J 23/50
USPC 502/5; 502/343

(57) ABSTRACT

A fibrous photo-catalyst includes titanium oxide, zinc oxide, and a transition metal. A molar ratio of the transition metal and the titanium oxide ranges from 0.1:100 to 8:100, and a molar ratio of the zinc oxide and the titanium oxide ranges from 5:100 to 50:100.

### CROSS-REFERENCE TO RELATED APPLICATIONS

This application claims priorities of Taiwanese Patent Application No. 102111340, filed on Mar. 29, 2013, and Taiwanese Patent. Application No. 103101793, filed on Jan. 17, 2014.

### BACKGROUND OF THE INVENTION

1. Field of the Invention

The invention relates to a photo-catalyst, more particularly to a fibrous photo-catalyst.

2. Description of the Related Art

Photo-catalysts are catalysts that can accelerate photo-chemical reactions by absorbing energy from light. Conventional photo-catalysts include TiO₂, GaS, GaAs or the like. Among the conventional photo-catalysts, TiO₂ is most popular due to its advantages such as strong resistance to acids, bases, and organic solvents, non-toxicity and abundant supply.

However, since TiO₂ photo-catalysts can only absorb UV light to induce the catalyzing effect, where UV energy is merely about 5% of total energy of sunlight, TiO₂ photo-catalysts are thereby limited thereto. For example, conventional indoor fluorescent lamps merely provide 0.1 μW to 1 μW of UV energy which is not sufficient for most of the TiO₂ photo-catalysts to induce the catalyzing effect to decompose organic pollutants or to perform sterilization.

### SUMMARY OF THE INVENTION

Therefore, one object of the present invention is to provide a photo-catalyst that has a relatively high visible-light absorption rate.

Accordingly, a fibrous photo-catalyst of the present invention includes titanium oxide, zinc oxide, and a transition metal.

Another object of the present invention is to provide a method for producing a fibrous photo-catalyst.

Accordingly, a method for producing a fibrous photo-catalyst includes the following steps of:

mixing a titanium-containing precursor with an organic polymer and an organic solvent to obtain a primary solution;

adding transition metal ions and zinc ions into the primary solution, followed by heating so as to obtain an electrospinning solution; and

electrospinning the electrospinning solution to obtain the fibrous photo-catalyst.

### BRIEF DESCRIPTION OF THE DRAWINGS

Other features and advantages of the present invention will become apparent in the following detailed description of the preferred embodiments with reference to the accompanying drawings, of which:

FIG. 1 is a FE-SEM photograph illustrating a fibrous photo-catalyst of Example 3 according to the present invention;

FIG. 2 shows X-ray diffraction patterns of the fibrous photo-catalysts of Examples 2, and 4 to 6 according to the present invention;

FIG. 3 shows UV/visible-light absorption spectra of the fibrous photo-catalyst of each of Examples 1 to 3 and Comparative Example 1; and

FIG. 4 is a graph illustrating photo-degradation rate of methylene blue with respect to visible-light exposure period of the fibrous photo-catalyst of each of Examples 1 and 2 and Comparative Examples 2 and 3.

### DETAILED DESCRIPTION OF THE PREFERRED EMBODIMENTS

The preferred embodiment of a fibrous photo-catalyst according to the present invention includes titanium oxide, zinc oxide, and a transition metal.

Preferably, a molar ratio of the transition metal and the titanium oxide of the fibrous photo-catalyst ranges from 0.1:100 to 8:100, and a molar ratio of the zinc oxide and the titanium oxide of the fibrous photo-catalyst ranges from 5:100 to 50:100. More preferably, the molar ratio of the transition metal and the titanium oxide ranges from 0.5:100 to 5:100, even more preferably from 2:100 to 5:100.

Preferably, the titanium oxide is anatase TiO₂ or anatase/rutile TiO₂.

Preferably, the transition metal is selected from the group consisting of silver, palladium, rhodium, gold, iridium, cobalt, nickel, zirconium, and combinations thereof. More preferably, the transition metal is silver.

Preferably, the fibrous photo-catalyst has a diameter ranging from 0.01 μm to 3 μm. In this embodiment, the diameter of the fibrous photo-catalyst ranges from 0.10 μm to 0.30 μm.

Preferably, the fibrous photo-catalyst has a photo-degradation rate of methylene blue that is greater than 30% in one hour under exposure to visible light.

The preferred embodiment of a method for producing the aforesaid fibrous photo-catalyst according to the present invention includes the following steps of:

mixing a titanium-containing precursor with an organic polymer and an organic solvent to obtain a primary solution;

adding transition metal ions and zinc ions into the primary solution, followed by heating so as to obtain an electrospinning solution; and

electrospinning the electrospinning solution to obtain the fibrous photo-catalyst.

Preferably, a molar ratio of the transition metal ions and the titanium-containing precursor ranges from 0.1:100 to 8:100, and a molar ratio of the zinc ions and the titanium-containing precursor ranges from 5:100 to 50:100.

Preferably, the transition metal ions are silver ions.

Preferably, the organic polymer is selected from the group consisting of polyvinylpyrrolidone (PVP), polyethylene glycol (PEG), polyvinyl alcohol (PVA), and an ethylene oxide/propylene oxide based block copolymer (such as Pluronic®). In this embodiment, the organic polymer is polyvinylpyrrolidone (PVP).

Preferably, the organic solvent is selected from the group consisting of ethanol, acetic acid and the combination thereof.

Preferably, the method further includes a step of calcining the fibrous photo-catalyst after electrospinning.

Preferably, calcining the fibrous photo-catalyst is conducted at a temperature ranging from 450° C. to 600° C.

Preferably, during the electrospinning step, a distance between a spinning tip and a collector ranges from 1 cm to 50 cm. In this embodiment, the distance between the spinning tip and the collector ranges from 15 cm to 16 cm.

Preferably, during the electrospining step, a flow rate of the electrospinning solution ranges from 0.001 mL/min to 1 mL/min. In this embodiment, the introduction rate of the electrospinning solution is 0.021 mL/min.

Preferably, during the electrospinning step, an applied voltage for the electrospinning solution ranges from 0.1 kV to 300 kV. In this embodiment, 15 kV is applied to the electrospinning solution.

The following examples are provided to illustrate the preferred embodiment of the present invention, and should not be construed as limiting the scope of the invention.

### EXAMPLES

### Example 1 (E1)

### Fibrous Photo-Catalyst

Titanium(IV) isopropoxide (TIP), acetic acid, and ethanol were mixed at a volume ratio of 1:1:2, so as to form a titanium-containing precursor solution. Polyvinylpyrrolidone (PVP), having a mass average molecular weight of 1,300,000, was dissolved in ethanol to form a 10 wt % PVP solution. The titanium-containing precursor solution and the PVP solution were then mixed together at a volume ratio of 24:30, so as to obtain a primary solution. Thereafter, 0.5 N silver nitrate aqueous solution was added into the primary solution (the molar ratio of silver ions to titanium isopropoxide was 0.5:100), followed by addition of an aqueous solution containing zinc acetate and monoethanolamine (the weight ratio of zinc acetate, monoethanolamine and water was 1.135:0.32:0.186), heating to 60° C. under water bath for one hour and stirring for one day to obtain an electrospinning solution. The electrospinning solution was then subjected to an electrospinning step to obtain composite fibers. Parameters for the electrospinning step are listed in the following Table 1. The composite fibers were then wrapped with an aluminum foil and placed in a furnace to calcine at 450° C. for one hour, so as to obtain the fibrous photo-catalyst of Example 1.

TABLE 1

| | | |
|---|---|---|
| Distance between a spinning | 15~16 | cm |
| tip* and a collector** | | |
| Flow rate of the | 0.021 | mL/min |
| electrospinning solution | | |
| Applied voltage | 15 | kV |
| Rotating speed of the collector | 1200 | rpm |

*The spinning tip is a stainless steel needle.
**The collector is a roller provided with a metal foil thereon, having a roller diameter of 20 cm and a width of 3 cm.

### Examples 2 and 3 (E2 and E3)

The method for producing the fibrous photo-catalyst of each of E2 and E3 was similar to that of E1. The difference resides in that the molar ratios of the silver ions to the titanium-containing precursor of the fibrous photo-catalyst of E2 and E3 were 2.0:100 and 4.8:100, respectively.

### Examples 4 to 6 (E4 to E6)

The method for producing the fibrous photo-catalyst of each of E4 to E6 was similar to that of E2. The differences therebetween reside in that the composite fibers of E4 to E6 were calcined at 500° C., 550° C., and 600° C., respectively.

### Comparative Example 1 (CE1)

Titanium(IV) isopropoxide (TIP), acetic acid, and a PVP solution (10 wt % in ethanol) were mixed together under a volume ratio of 1:1:2 and stirred for one day to form an electrospinning solution, followed by electrospinning the electrospinning solution to form the composite fibers. Parameters for the electrospinning step were the same as those for Example 1. Thereafter, the composite fibers were calcined at 450° C. for one hour, so as to obtain the fibrous photo-catalyst of CE1.

### Comparative Examples 2 and 3 (CE2 and CE3)

The method for producing the fibrous photo-catalyst of each of CE2 and CE3 was similar to that of CE1. The differences therebetween reside in that the composite fibers of CE2 and CE3 were calcined at 550° C. and 600° C., respectively.

### [Observation of the Fibrous Photo-Catalyst]

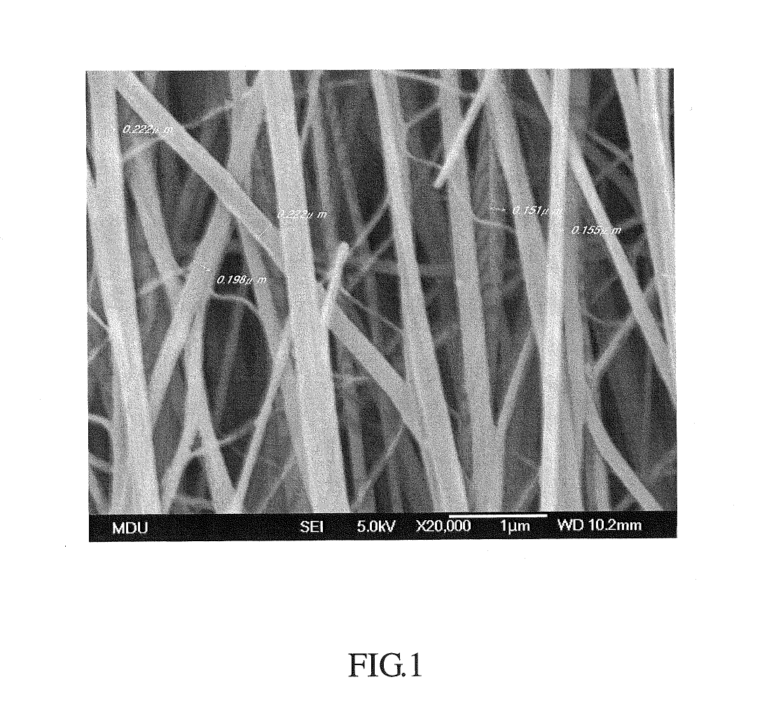

The fibrous photo-catalyst of E3 was cut into a predetermined size and was coated with platinum in vacuum, followed by being observed using a FE-SEM (commercially available from Hitachi Co., Model # S4800-I, magnification ×20000). A software Image-J was utilized to analyze captured images of the fibrous photo-catalyst, and the result is shown in FIG. 1. As depicted in FIG. 1, the fibrous photo-catalyst of E3 is in a fibrous shape and has a diameter ranging from 0.1 μm to 0.3 μm, indicating that the fibrous photo-catalyst of E3 is within a nanometer scale.

### [X-ray Diffraction Analysis]

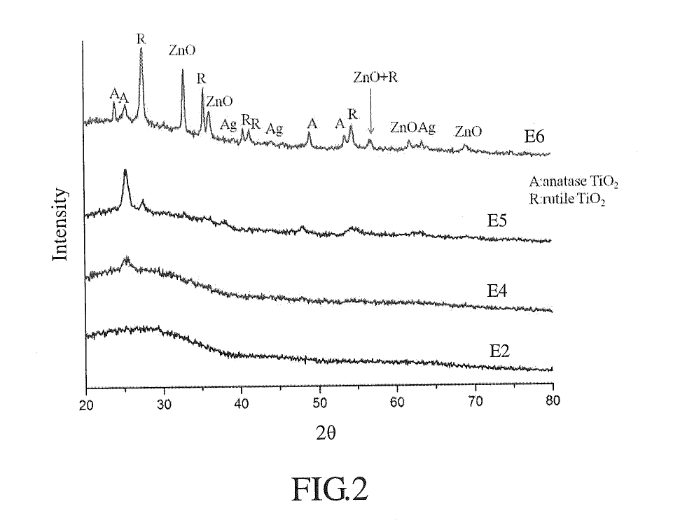

The fibrous photo-catalyst of each of E2 and E4 to E6 was subjected to X-ray diffraction analysis using X-ray diffractometer (XRD, commercially available from PANalytical, Model#: X'Pert Pro MRD), and the results are shown in FIG. 2.

As shown in FIG. 2, crystal phases start growing with increased calcining temperature. When the calcining temperature was at 500° C. (E4), a characteristic peak representing anatase TiO₂ starts to show up (2θ is around 25.1°). When the calcining temperature was raised to 550° C. (E5), the anatase TiO₂ peak grows significantly. When the calcining temperature was raised to 600° C. (E6), characteristic peaks representing rutile TiO₂ (2θ=27.8°), ZnO (2θ=34.5°), and silver starts to show up. The XRD result indicates that TiO₂ of the fibrous photo-catalyst each of E2, and E4 to E6 is either anatase TiO₂, or a mixture of anatase TiO₂ and rutile TiO₂.

### [Visible-Light Absorption]

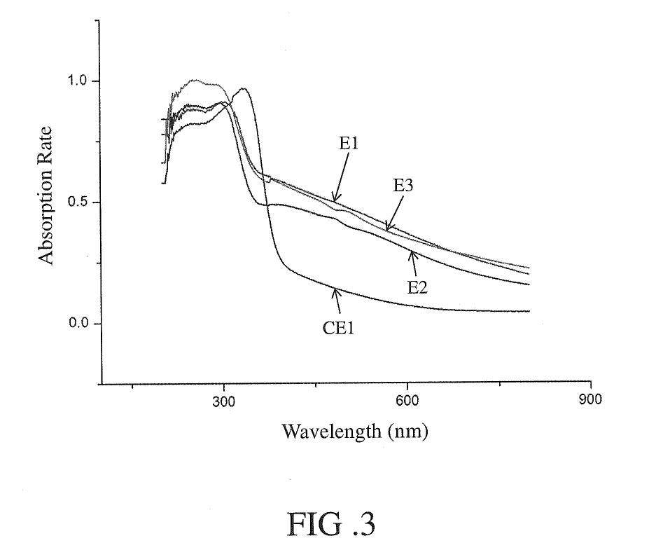

The fibrous photo-catalyst of each of E1 to E3 and CE1 was subjected to visible-light absorption measurement using UV-Visible spectrophotometer (commercially available from PerkinElmer Precisely, Mode#: Lambda 850), and the obtained spectra are shown in FIG. 3.

As shown in FIG. 3, the fibrous photo-catalyst of E1 to E3 have relatively higher absorption rates within the visible-light wavelength zone (400 to 750 nm) in comparison to those of CE1, indicating that the fibrous photo-catalyst of the present invention has higher efficiency in absorbing visible light.

### [Specific Surface Area Measurement]

The fibrous photo-catalyst of E2 and CE1 were subjected to specific surface area measurement using a BET surface area analyzer (commercially available from Micromeritics, Model#: ASAP 2010). The specific surface areas of E2 and CE1 are 149.83±0.36 m²/g and 49.9098±0.4126 m²/g, respectively, indicating that the fibrous photo-catalyst of the present invention has relatively high specific surface area which is beneficial to adsorb more particles.

### [Photo-Degradation Measurement]

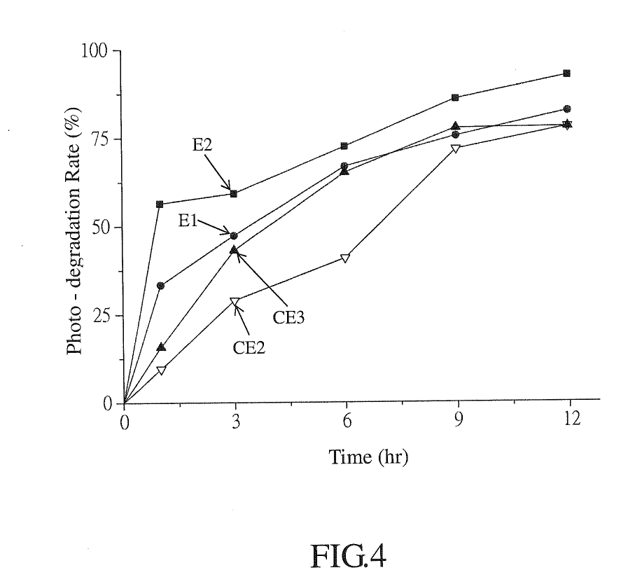

0.01 gram of the fibrous photo-catalyst of each of E1, E2, CE2, and CE3 was added into a 5×10⁻⁶ M methylene blue aqueous solution to perform photo-degradation reaction under exposure to visible light. The visible-light source is a fluorescent lamp (commercially available from Philips, Model#: TL-D 18 W/865) provided with a piece of anti-UV glass to block out light having a wavelength of 400 nm or lower. After being exposed for 1, 3, 6, 9, and 12 hours, few of the methylene blue solution was taken out for centrifugation and UV-Visible light absorption measurement, so as to obtain the concentration of methlyene blue and to calculate the methylene blue photo-degradation rate. The results are shown in FIG. 4.

As shown in FIG. 4, the fibrous photo-catalysts of E1 and E2 have significantly high photo-degradation rate at the beginning of the visible-light exposure period in comparison to those of CE1 and CE2. Specifically, the fibrous photo-catalyst of E2 reached a photo-degradation rate of 80% after 9 hours of exposure to the visible light, indicating that the fibrous photo-catalyst of the present invention can efficiently generate catalyzing effect under exposure to visible light. Besides, the calcining temperature of E1 and E2 (450° C.) were lower than those of CE2 and CE3 (550° C. and 600° C.), thereby lowering the production cost.

To sum up, the fibrous photo-catalyst of the present invention has relatively high specific surface area and can efficiently absorb visible light, so as to quickly decompose organic pollutants.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fibrous photo-catalyst comprising:
titanium oxide;
zinc oxide; and
a transition metal.

2. The fibrous photo-catalyst according to claim 1, wherein a molar ratio of the transition metal and the titanium oxide ranges from 0.1:100 to 8:100, and a molar ratio of the zinc oxide and the titanium oxide ranges from 5:100 to 50:100.

3. The fibrous photo-catalyst according to claim 1, wherein said transition metal is selected from the group consisting of silver, palladium, rhodium, gold, iridium, cobalt, nickel, zirconium, and combinations thereof.

4. The fibrous photo-catalyst according to claim 3, wherein said transition metal is silver.

5. The fibrous photo-catalyst according to claim 1, having a photo-degradation rate of methylene blue that is greater than 30% in one hour under exposure to visible light.

6. A method for producing a fibrous photo-catalyst, comprising the following steps of:
mixing a titanium-containing precursor with an organic polymer and an organic solvent to obtain a primary solution;
adding transition metal ions and zinc ions into the primary solution, followed by heating so as to obtain an electrospinning solution; and
electrospinning the electrospinning solution to obtain the fibrous catalyst.

7. The method of claim 6, wherein a molar ratio of the transition metal ions and the titanium-containing precursor ranges from 0.1:100 to 8:100, and a molar ratio of the zinc ions and the titanium precursor ranges from 5:100 to 50:100.

8. The method of claim 6, wherein the transition metal ions are silver ions.

9. The method of claim 6, wherein the organic polymer is selected from the group consisting of polyvinylpyrrolidone, polyethylene glycol, polyvinyl alcohol, and an ethylene oxide/propylene oxide based block copolymer.

10. The method of claim 6, further comprising a step of calcining the fibrous photo-catalyst after electrospinning.

11. The method of claim 10, wherein calcining the fibrous photocatalyst is conducted at a temperature ranging from 450° C. to 600° C.
